(19) United States
(12) Patent Application Publication
(10) Pub. No.: US 2018/0020372 A1
(43) Pub. Date: Jan. 18, 2018

(54) METHOD AND APPARATUS FOR REPORTING QUANTITY OF DATA TO BE TRANSMITTED IN A WIRELESS NETWORK

(71) Applicant: CANON KABUSHIKI KAISHA, Tokyo (JP)

(72) Inventors: Pascal VIGER, JANZE (FR); Stéphane BARON, LE RHEU (FR); Patrice NEZOU, LIFFRE (FR)

(21) Appl. No.: 15/644,503

(22) Filed: Jul. 7, 2017

(30) Foreign Application Priority Data
Jul. 13, 2016 (GB) 1612194.9

(51) Int. Cl. H04W 28/02; H04W 92/10

(52) U.S. Cl. CPC H04W 28/0278; H04W 92/10

(57) ABSTRACT

A method of communication in a wireless network comprising a plurality of wirelessly communicating stations, the method comprising by at least one emitting station having data to be directly transmitted to at least two different destination stations, generating a buffer status report to be transmitted to one of the destination stations, the buffer status report indicating an amount of data stored in at least an emission buffer of the emitting station, the emission buffers comprising all data to be transmitted to all the destination stations; transmitting the buffer status report to the destination station; wherein the amount of data is limited to the amount of data stored in at least an emission buffer of the emitting station to be transmitted to the destination station that will receive the buffer status report. Accordingly, scheduled traffic by a station is made with an accurate amount of data.

### PRIORITY CLAIM/INCORPORATION BY REFERENCE

This application claims the benefit under 35 U.S.C. §119(a)-(d) of United Kingdom Patent Application No. 1612194.9, filed on Jul. 13, 2016 and entitled “METHOD AND APPARATUS FOR REPORTING QUANTITY OF DATA TO BE TRANSMITTED IN A WIRELESS NETWORK”. The above cited patent application is incorporated herein by reference in its entirety.

### FIELD OF THE INVENTION

The present invention relates generally to communication networks and more specifically to wireless communication methods in wireless network comprising a plurality of stations, one of these stations playing the role of an access point, the other stations being connected to the access point, and corresponding devices.

The invention finds application in wireless communication networks, in particular to the access of an 802.11ax composite channel and of OFDMA Resource Units forming for instance an 802.11ax composite channel for Uplink communication to the access point. One application of the method regards wireless data communication over a wireless communication network using Carrier Sense Multiple Access with Collision Avoidance (CSMA/CA), the network being accessible by a plurality of station devices.

### BACKGROUND OF THE INVENTION

A wireless network is composed of communicating stations. Typically, one of these stations plays the role of an access point. This access point station gives access to a more global network. All other stations, the non access point stations, are connected to the access point station. Using their connection to the access point station, the non access point stations have access to the global network. They also can communicate with other non access point station through the access point station. Some protocols have recently being introduced to also allow direct communication between non access point stations. In the following, the word “station” refers to any kind of stations. We will use the wording “access point station”, or in short “access point”, to refer to the station playing the role of access point and the wording “non access point station” to refer to the other stations not playing this role.

The IEEE 802.11 MAC standard defines a way wireless local area networks (WLANs) must work at the physical and medium access control (MAC) level. Typically, the 802.11 MAC (Medium Access Control) operating mode implements the well-known Distributed Coordination Function (DCF) which relies on a contention-based mechanism based on the so-called “Carrier Sense Multiple Access with Collision Avoidance” (CSMA/CA) technique.

The 802.11 medium access protocol standard or operating mode is mainly directed to the management of communication stations waiting for the wireless medium to become idle so as to try to access to the wireless medium.

The network operating mode defined by the IEEE 802.11ac standard provides very high throughput (VHT) by, among other means, moving from the 2.4 GHz band which is deemed to be highly susceptible to interference to the 5 GHz band, thereby allowing for wider frequency contiguous channels of 80 MHz to be used, two of which may optionally be combined to get a 160 MHz composite channel as operating band of the wireless network.

The 802.11ac standard also provides control frames such as the Request-To-Send (RTS) and Clear-To-Send (CTS) frames, involved in a well-known RTS/CTS handshake, to allow reservation of composite channels of varying and predefined bandwidths of 20, 40 or 80 MHz, the composite channels being made of one or more channels that are contiguous within the operating band. The 160 MHz composite channel is possible by the combination of two 80 MHz composite channels within the 160 MHz operating band. The control frames specify the channel width (bandwidth) for the targeted (or “requested”) composite channel.

A composite channel therefore consists of a primary channel on which a given station performs EDCA backoff procedure to access the medium, and of at least one secondary channel, of for example 20 MHz each. The EDCA backoff procedure consists in randomly generate a backoff value which is a timer defining a waiting duration before the next attempt to emit on the channel when a collision has been detected. The primary channel is used by the communication stations to sense whether or not the channel is idle, and the primary channel can be extended using the secondary channel or channels to form a composite channel.

Given a tree breakdown of the operating band into elementary 20 MHz channels, some secondary channels are named tertiary or quaternary channels.

In 802.11ac, all the transmissions, and thus the possible composite channels, include the primary channel. This is because the stations perform full Carrier Sense Multiple Access/Collision Avoidance (CSMA/CA) and Network Allocation Vector (NAV) tracking on the primary channel only. The Network Allocation Vector defines a duration during which a station mustn't access the channel. The other channels are assigned as secondary channels, on which the 802.11ac stations have only capability of CCA (clear channel assessment), i.e. detection of an availability state/status (idle or busy) of said secondary channel.

An issue with the use of composite channels as defined in the 802.11n or 802.11ac is that the 802.11n and 802.11ac-compliant stations (i.e. HT stations standing for High Throughput stations) and the other legacy stations (i.e. non-HT stations compliant only with for instance 802.11a/b/g) have to co-exist within the same wireless network and thus have to share the 20 MHz channels.

To cope with this issue, the 802.11n and 802.11ac standards provide the possibility to duplicate control frames (e.g. RTS/CTS or CTS-to-Self or ACK frames to acknowledge correct or erroneous reception of the sent data) on each 20 MHz channel in an 802.11a legacy format (called as “non-HT”) to establish a protection of the requested channels forming the whole composite channel, during the TXOP. The TXOP is a bounded time interval in which stations are permitted to transfer a series of frames. A TXOP is defined by a start time and a maximum duration.

This is for any legacy 802.11a station that uses any of the 20 MHz channel involved in the composite channel to be aware of on-going communications on the 20 MHz channel used. As a result, the legacy station is prevented from initiating a new transmission until the end (as set on the NAV parameter) of the current composite channel TXOP granted to an 802.11n/ac station.

As originally proposed by 802.11n, a duplication of conventional 802.11a or “non-HT” transmission is provided to allow the two identical 20 MHz non-HT control frames to be sent simultaneously on both the primary channel and the secondary channels forming the requested and used composite channel.

This approach has been widened for 802.11ac to allow duplication over the channels forming an 80 MHz or 160 MHz composite channel. In the remainder of the present document, the “duplicated non-HT frame” or “duplicated non-HT control frame” or “duplicated control frame” means that the station device duplicates the conventional or “non-HT” transmission of a given control frame over secondary 20 MHz channels of the (40/80/160 MHz) operating band.

In practice, to request a composite channel (equal to or greater than 40 MHz) for a new TXOP, an 802.11n/ac station does an EDCA backoff procedure in the primary 20 MHz channel wherein one or more backoff counters are decremented. In parallel, it performs a channel sensing mechanism, such as a Clear-Channel-Assessment (CCA) signal detection, on the secondary channels to detect the secondary channel or channels that are idle (channel state/status is “idle”) during a PIFS interval before sending a request for the new TXOP (i.e. before the backoff counter expires).

More recently, Institute of Electrical and Electronics Engineers (IEEE) officially approved the 802.11ax task group, as the successor of 802.11ac. The primary goal of the 802.11ax task group consists in seeking for an improvement in data speed to wireless communicating devices used in dense deployment scenarios.

Recent developments in the 802.11ax standard sought to optimize usage of the composite channel by multiple stations in a wireless network having an access point (AP). Indeed, typical contents have important amount of data, for instance related to high-definition audio-visual real-time and interactive content. Furthermore, it is well-known that the performance of the CSMA/CA protocol used in the IEEE 802.11 standard deteriorates rapidly as the number of stations and the amount of traffic increase, i.e. in dense WLAN scenarios.

In this context, multi-user (MU) transmission has been considered to allow multiple simultaneous transmissions to/from different users in both downlink (DL) and uplink (UL) directions from/to the access point. In the uplink to the access point, multi-user transmissions can be used to mitigate the collision probability by allowing multiple stations to simultaneously transmit.

To actually perform such multi-user transmission, it has been proposed to split a granted 20 MHz channel into one or more sub-channels, also referred to as resource units (RUs), that are shared in the frequency domain by the multiple stations, based for instance on Orthogonal Frequency Division Multiple Access (OFDMA) technique. Each resource unit may be defined by a number of tones, the 20 MHz channel containing up to 242 usable tones. A tone corresponds to the basic subcarrier to be used for transmission.

OFDMA is a multi-user variation of OFDM which has emerged as a new key technology to improve efficiency in advanced infrastructure-based wireless networks. It combines OFDM on the physical layer with Frequency Division Multiple Access (FDMA) on the MAC layer, allowing different subcarriers to be assigned to different stations in order to increase concurrency. Adjacent sub-carriers often experience similar channel conditions and are thus grouped to sub-channels: an OFDMA sub-channel or resource unit is thus a set of sub-carriers.

The multi-user feature of OFDMA allows the access point to assign different resource units to different stations in order to increase competition. This may help to reduce contention and collisions inside 802.11 networks.

As currently envisaged, the granularity of such OFDMA sub-channels is variable and may be finer than the original 20 MHz channel band. Typically, a 2 MHz or 5 MHz sub-channel may be contemplated as a minimal width, therefore defining for instance 9 sub-channels or resource units within a single 20 MHz channel.

To support multi-user uplink, i.e. uplink transmission to the 802.11ax access point (AP) during the granted TXOP, the 802.11ax access point has to provide signalling information for the legacy stations (non-802.11ax stations) to set their NAV in order to prevent them from accessing channels during the TXOP, and for the 802.11ax stations to determine the allocation of the resource units.

It has been proposed for the access point to send a trigger frame (TF) to the 802.11ax stations to trigger uplink communications. A trigger frame is a control frame derived from a RTS frame with an additional payload to communicate additional signalling information like resource units allocation for example.

A resource unit can be reserved for a specific station, in which case the access point indicates, in the TF, the station to which the resource unit is reserved (the Association ID (AID) is provided to indicate which 802.11ax station is allowed to use the resource unit). Such resource unit is called a Scheduled resource unit. The indicated station does not need to perform contention on accessing a scheduled resource unit reserved to it.

Another kind of resource units can be accessed by any stations using contention access. Such resource unit is not allocated to a particular station. It means that the stations compete for accessing such resource units. Such resource units are called Random resource units, and are indicated in the Trigger Frame with special station (STA) identification (e.g., value of Association ID (AID) is 0).

Since the access point performs contention on behalf of the STAs in this uplink OFDMA scheme, it is greatly preferable that the access point should be aware of which 802.11ax stations hold uplink packets to transmit and what their related emission buffer sizes are.

The 802.11e standard brought the quality of service mechanism. According to this mechanism the previously unique emission buffer has been split into four different emission buffers corresponding to four different access categories. Each access category corresponds to two different priorities, each emission buffer consequently holds data having two different priorities. Each of the eight priority level is identified by a traffic identifier (TID). The 802.11e standard has also brought the mechanism of buffer status report (BSR). This mechanism provides a means for a station to report to the access point station the amount of data held in an emission buffer ready to be transmitted to the access point station. The buffer status report mechanism is consequently adapted to report the amount of data held in the emission buffers corresponding to a given TID.

Thanks to these reports, the access point is in charge of determining the width and duration of the uplink resource units for PPDU transmissions (PPDU length). All concerned 802.11ax stations (those explicitly solicited by the access point through a scheduled resource unit allocation, or those determined through applying the OFDMA random access procedure) make the uplink transmission with the indicated duration inside the indicated resource units. If a 802.11ax station's packet length is shorter or longer than the indicated duration, this packet should be padded or fragmented to make all uplink OFDMA transmissions finish at the same time (note that the access point is free to offer different resource unit widths inside a same MU UL transmission opportunity).

As one can note, buffer status knowledge has become the critical point for the access point, acting as the central control entity for MU UL allocation: if stations without expected amount of uplink packets are polled for uplink OFDMA transmission, allocated uplink resources are wasted leading to system throughput degradation.

However, there are situations where the current version of buffer size reporting according to the 802.11 standard is not satisfactory, and conducting the access point to faulty allocate, to one or the other of these several stations, the resource units over which MU UL communications may take place. Exemplary situation, corresponding to an increasing trend nowadays, is the presence of peer-to-peer (P2P) transmissions in between non-AP stations, (e.g. WiFi-Miracast or Wireless Display scenario). Even if such flows are not numerous, the amount of data per flow is huge (typically low-compressed video, from 1080p60 up to 8K UHD resolutions). This peer to peer data is buffered in the same emission buffers as the uplink traffic to the access point, even if it is not intended to be transmitted to the access point.

### SUMMARY OF INVENTION

The present invention has been devised to address one or more of the foregoing concerns.

According to a first aspect of the invention there is provided a method of communication in a wireless network comprising a plurality of wirelessly communicating stations, the method comprising by at least one emitting station having data to be directly transmitted to at least two different destination stations:
generating a buffer status report to be transmitted to one of the destination stations, said buffer status report indicating an amount of data stored in at least an emission buffer of the emitting station, said emission buffers comprising all data to be transmitted to all the destination stations;
transmitting said buffer status report to the destination station; wherein
   said amount of data is limited to the amount of data stored in at least an emission buffer of the emitting station to be transmitted to the destination station that will receive the buffer status report.

Accordingly, the emitting station reports an amount of data to be transmitted to the destination station which allows the destination station to generate an accurate allocation for a scheduled data frame.

In an embodiment, one station playing the role of access point, the other stations being connected to the access point station, wherein the destination station that will receive the buffer status report is the access point station.

In an embodiment, data to be transmitted to a non access point station are to be emitted according to an established direct link.

In an embodiment, said established direct link is of single-user type.

In an embodiment, the method further comprises:
maintaining by the emitting station a value representative of an amount of data stored in the emission buffers per final destination station of the stored data.

Accordingly, the amount of data to report in a buffer status report is simple to generate.

In an embodiment, data being transmitted according to a plurality of traffic identifiers, said maintained value representative of an amount of data is maintained per final destination and per traffic identifier.

Accordingly, any granularity of buffer status report may be easily generated.

In an embodiment, the method further comprises for generating the buffer status report the steps of:
determining the list of all final destination stations which traffic is to be transmitted through the destination station that will receive the buffer status report for at least one given traffic identifier;
adding the maintained values representative of an amount of data relating to the determined list of final destination stations for at least one given traffic identifier.

In an embodiment, the method further comprises:
receiving a trigger frame for buffer status report; and wherein
generating a buffer status report is done in response to the reception of the trigger frame for buffer status reports.

In an embodiment, said trigger frame for buffer status report comprises an information related to whether the buffer status report should be established for a given traffic identifier, a given access category or a plurality of access categories.

In an embodiment, generating a buffer status report is done for an introduction within a data frame to be transmitted.

In an embodiment, the buffer status report comprises duration information corresponding to said amount of data to be transmitted on a single 20 MHz channel.

In an embodiment, use of duration information in a buffer status report is forbidden.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a computer-readable storage medium storing instructions of a computer program for implementing a method according to the invention.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical wireless communication system in which embodiments of the invention may be implemented;

FIGS. 2a, 2b and 2c illustrate the IEEE 802.11e EDCA involving access categories;

FIG. 3 illustrates 802.11ac channel allocation that supports composite channel bandwidths of 20 MHz, 40 MHz, 80 MHz or 160 MHz, as known in the art;

FIG. 4a illustrates, using a timeline, an example of 802.11ax OFDMA transmission scheme, wherein the access point issues a Trigger Frame for reserving a transmission opportunity of OFDMA resource units on an 80 MHz channel as known in the art;

FIG. 4b illustrates, using a timeline, an example of 802.11ax OFDMA transmission scheme, as known “buffer status feedback operation” by the 802.11ax standard, wherein the access point issues a sequence of two Trigger Frames for first requesting buffer status reports to 802.11ax stations and second scheduling OFDMA resource units to a subset of 802.11ax stations based on the collected buffer reports, over a transmission opportunity on an 80 MHz channel;

FIG. 5 illustrates, using a timeline, issues of the “buffer status feedback operation” scheme according 802.11ax standard, in case of the involvement of P2P communications between 802.11ax stations;

FIG. 6 shows a schematic representation a communication device or station in accordance with embodiments of the present invention;

FIG. 7 shows a block diagram schematically illustrating the architecture of a wireless communication device in accordance with embodiments of the present invention;

FIGS. 8a, 8b and 9 illustrate, using a flowchart, general steps at a non-AP 802.11ax station of the network, according to embodiments of the invention;

FIG. 10 illustrates, using a timeline, a scenario of reserving resource unit channels according to embodiments of the invention.

### DETAILED DESCRIPTION

The invention will now be described by means of specific non-limiting exemplary embodiments and by reference to the figures.

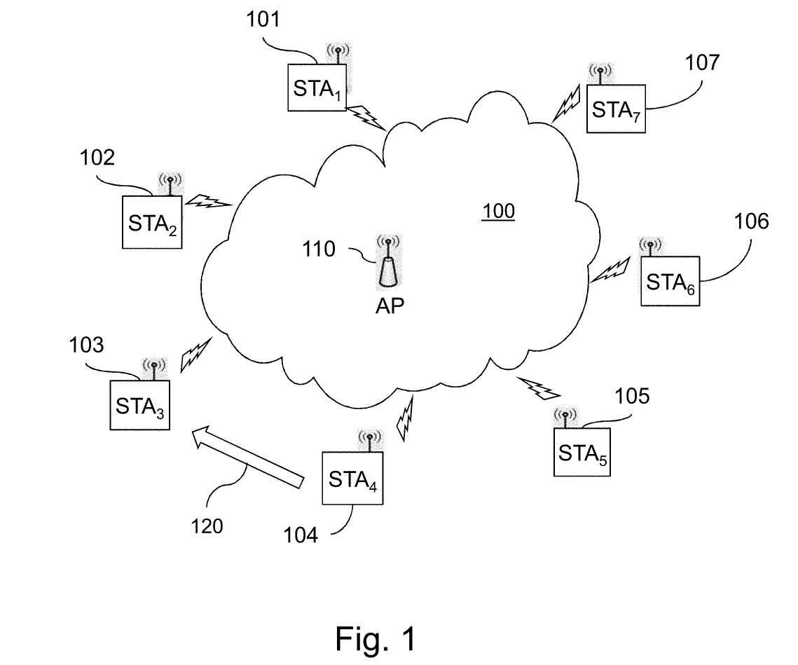

FIG. 1 illustrates a communication system in which several communication stations 101-107 exchange data frames over a radio transmission channel 100 of a wireless local area network (WLAN), under the management of a central station, or access point (AP) 110, also seen as a station of the network. The radio transmission channel 100 is defined by an operating frequency band constituted by a single channel or a plurality of channels forming a composite channel.

Access to the shared radio medium to send data frames is based on the CSMA/CA technique, for sensing the carrier and avoiding collision by separating concurrent transmissions in space and time. Carrier sensing in CSMA/CA is performed by both physical and virtual mechanisms. Virtual carrier sensing is achieved by transmitting control frames to reserve the medium prior to transmission of data frames. Next, a source or transmitting station first attempts, through the physical mechanism, to sense a medium that has been idle for at least one DIFS (standing for DCF InterFrame Spacing) time period, before transmitting data frames.

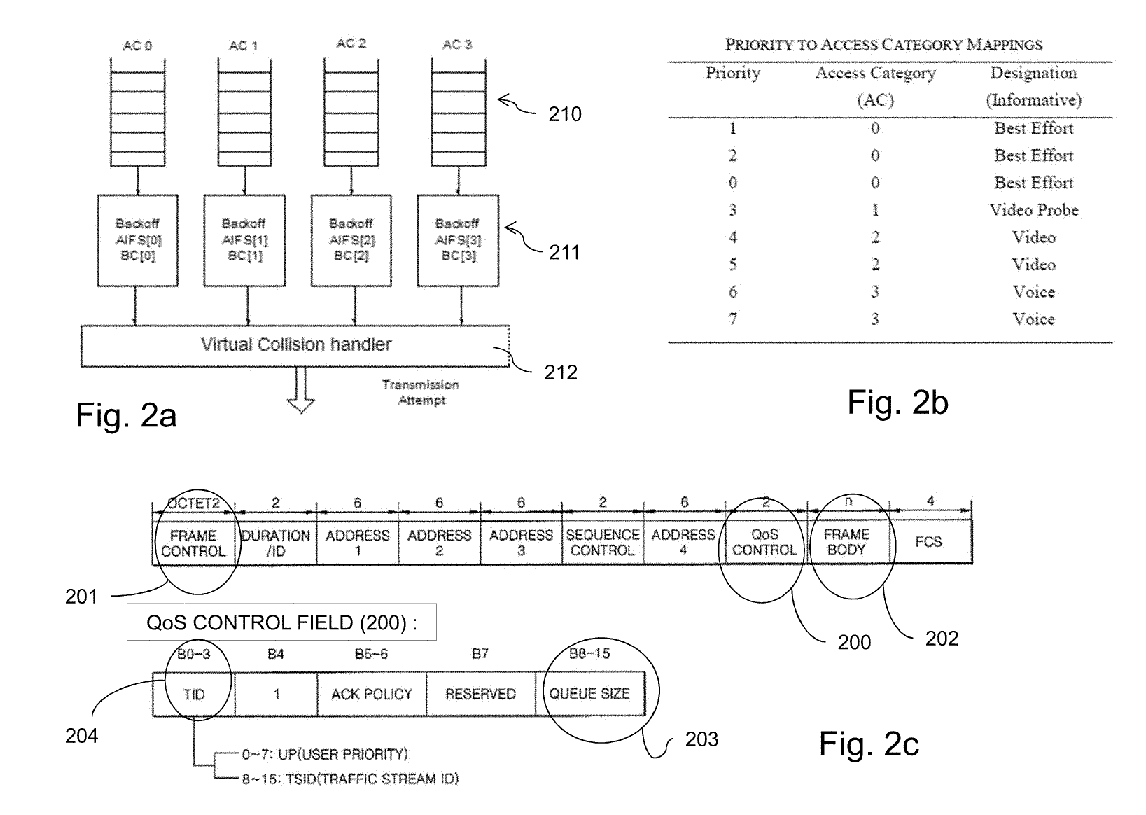

However, if it is sensed that the shared radio medium is busy during the DIFS period, the source station continues to wait until the radio medium becomes idle. Access to the medium is driven by a backoff counter (see FIG. 2a) that is decremented over time, to defer the transmission time for a random interval, thus reducing the probability of collisions on the shared channel. Upon the backoff time expiring, the source station may send data or control frames if the medium is idle.

The wireless communication system of FIG. 1 comprises a physical access point station 110 configured to manage the WLAN BSS (Basic Service Set), i.e. a group of stations. Such BSS managed by an access point is called an infrastructure BSS. In the following, the term BSS will be used as an equivalent of infrastructure BSS. Once the BSS is established (AP wakes up), it is organized around the Access Point which can bridge traffic out the BSS onto a distribution network, or inside the BSS. Thus, members of the BSS talk to the access point only, which is in charge of relaying frames if targeted to another station of the BSS.

In order to avoid relaying communications by the access point, and thus optimizing wireless channel usage, some protocols have emerged to offer direct communications between stations 120.

Given the wide adoption of 802.11 in many kinds of devices, a natural way for the technology to progress is to provide station to station (peer-to-peer, P2P) connectivity, i.e. without the need of an Access Point (AP).

Direct Link Setup (DLS), published in 802.11e, allows direct station-to-station frame transfer within a basic service set. This is designed primarily for consumer use, where station to station transfer is more commonly used. However, DLS requires participation from the access point to facilitate the more efficient direct communication, and few, if any, access points have the necessary support for this.

Later, 802.11z published the Tunneled Direct Link Setup (TDLS), allowing devices to perform more efficient direct station to station frame transfers without support from the access point. Wi-Fi Alliance added a certification program for TDLS in 2012, and describes this feature as technology that enables stations to link directly to one another when connected to a traditional infrastructure network.

Both DLS and TLDS require that stations be associated with the same access point.

In complement, nearby communication between devices not associated with the same access point can be performed using technologies like Wi-Fi Direct, initially called Wi-Fi P2P (peer to peer), which is also a technology defined by the Wi-Fi Alliance aiming at enhancing direct device to device communications in Wi-Fi. Given the wide base of devices provided with Wi-Fi capabilities and the fact that Wi-Fi Direct can be entirely software implemented over traditional 802.11 radios, this technology is expected to have a significant impact.

Common electronic devices having undergone certification of Wi-Fi, such as mobile terminals, printers, monitors, TVs, and game consoles, may perform direct wireless communication with each other using the Wi-Fi Direct or TDLS technologies.

Communications inside a P2P group are concurrent to communications of the infrastructure network (those including the access point 110). That is, the stations involved at the same time in the P2P communications and BSS network have their transmission queue(s) served with data from both traffic modes.

FIGS. 2a, 2b and 2c illustrate the IEEE 802.11e EDCA involving access categories, in order to improve the quality of service (QoS). In the original DCF standard, a communication station includes only one transmission queue/buffer. However, since a subsequent data frame cannot be transmitted until the transmission/retransmission of a preceding frame ends, the delay in transmitting/retransmitting the preceding frame prevents the communication from having QoS.

The IEEE 802.11e has overturned this deficiency in providing quality of service (QoS) enhancements to make more efficient use of the wireless medium. This standard relies on a coordination function, called Hybrid Coordination Function (HCF), which has two modes of operation: Enhanced Distributed Channel Access (EDCA) and HCF Controlled Channel Access (HCCA).

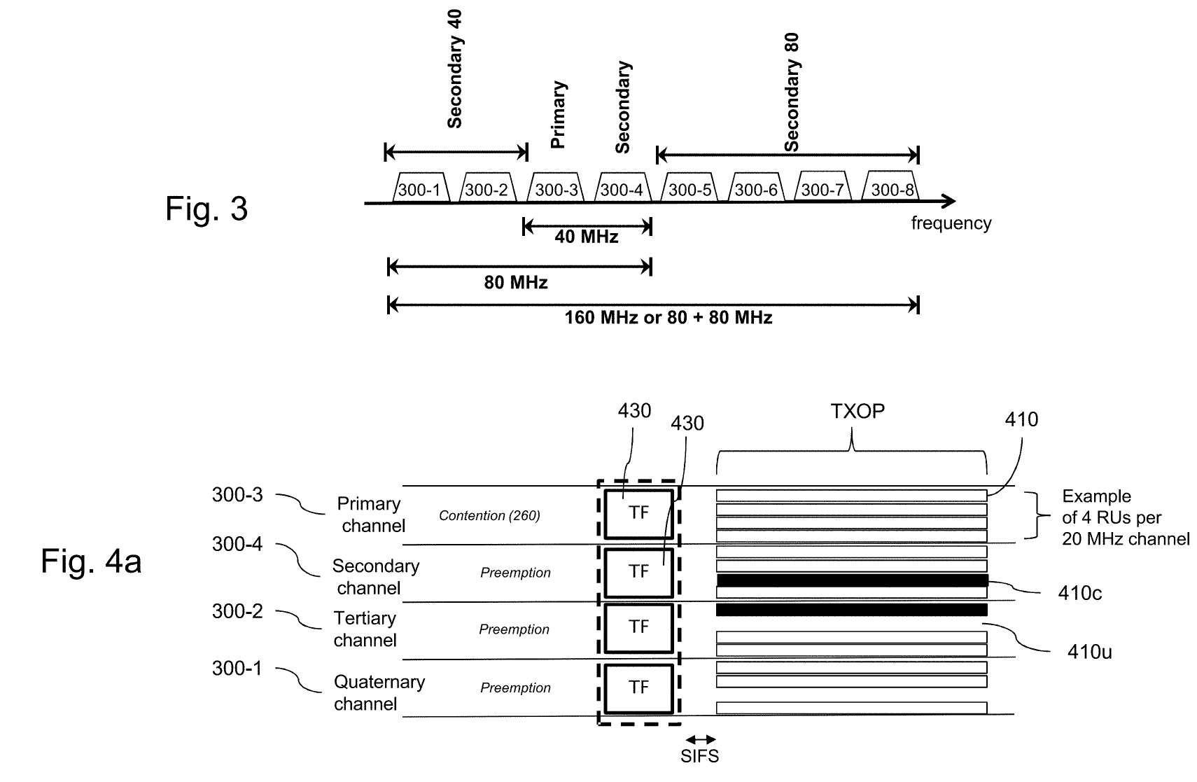

EDCA enhances or extends functionality of the original access DCF method: EDCA has been designed for support of prioritized traffic similar to DiffServ (Differentiated Services), which is a protocol for specifying and controlling network traffic by class so that certain types of traffic get precedence. EDCA is the dominant channel access mechanism in WLANs because it features a distributed and easily deployed mechanism. As will be apparent further in the description, the EDCA medium access is still existing in 802.11ax standard as the fundamental legacy protocol, that is to say it is in concurrency to the newly introduced Multi-User OFDMA of 802.11ax as illustrated in FIG. 3.

The above deficiency of failing to have satisfactory QoS due to delay in frame retransmission has been solved with a plurality of transmission queues/buffers. QoS support in EDCA is achieved with the introduction of four Access Categories (ACs), and thereby of four corresponding emission buffers (or transmission/traffic queues or buffers) 210. Of course, another number of traffic queues may be contemplated. Each AC has its own traffic queue/buffer to store corresponding data frames to be transmitted on the network. The data frames, namely the MSDUs, incoming from an upper layer of the protocol stack are mapped onto one of the four AC queues/buffers and thus input in the mapped AC buffer.

Each AC has also its own set of channel access parameters or “queue backoff parameters”, and is associated with a priority value, thus defining traffic of higher or lower priority of MSDUs. Thus, there is a plurality of traffic queues for serving data traffic at different priorities. That means that each AC, and corresponding buffer, acts as an independent DCF contending entity including its respective queue backoff engine 211. Thus, each queue backoff engine 211 is associated with a respective traffic queue for computing a respective queue backoff value to be used to contend access to at least one communication channel in order to transmit data stored in the respective traffic queue.

It results that the ACs within the same communication station compete one with each other to access the wireless medium and to obtain a transmission opportunity. Service differentiation between the ACs is achieved by setting different queue backoff parameters between the ACs, such as different contention window parameters (CWₘᵢₙ, CWₘₐₓ), different arbitration interframe spaces (AIFS), and different transmission opportunity duration limits (TXOP_Limit).

With EDCA, high priority traffic has a higher chance of being sent than low priority traffic: a station with high priority traffic waits a little less (low CW) before it sends its packet, on average, than a station with low priority traffic.

The four AC buffers 210 are shown in FIG. 2a. Buffers AC3 and AC2 are usually reserved for real-time applications (e.g., voice or video transmission). They have, respectively, the highest priority and the penultimate highest priority. Buffers AC1 and AC0 are reserved for best effort and background traffic. They have, respectively, the penultimate lowest priority and the lowest priority.

Each data unit, MSDU, arriving at the MAC layer from an upper layer (e.g. Link layer) with a type of traffic (TID) priority is mapped into an AC according to mapping rules. FIG. 2b shows an example of mapping between eight priorities of traffic class (TID values between 0-7 are considered user priorities and these are identical to the IEEE 802.1D priority tags) and the four ACs. The data frame is then stored in the buffer corresponding to the mapped AC.

When the EDCA backoff procedure for a traffic queue (or an AC) ends, the MAC controller (reference 704 in FIG. 7 below) of the transmitting station transmits a data frame from this traffic queue to the physical layer for transmission onto the wireless communication network.

Since the ACs operate concurrently in accessing the wireless medium, it may happen that two ACs of the same communication station have their backoff ending simultaneously. In such a situation, a virtual collision handler 212 of the MAC controller operates a selection of the AC having the highest priority, as shown in FIG. 2b, between the conflicting ACs, and gives up transmission of data frames from the ACs having lower priorities. Then, the virtual collision handler commands those ACs having lower priorities to start again a backoff operation using an increased CW value.

FIG. 2c illustrates configurations of a MAC data frame and a QoS control field 200 included in the header of the IEEE 802.11e MAC frame. The MAC data frame also includes, among other fields, a Frame Control header 201 and a frame body 202. As represented in the Figure, the QoS control field 200 is made of two bytes, including the following information items:
Bits B0 to B3 are used to store a traffic identifier (TID) 204 which identifies a traffic stream. The traffic identifier takes the value of the transmission priority value (User Priority UP, value between 0 and 7—see FIG. 2b) corresponding to the data conveyed by the data frame or takes the value of a traffic stream identifier, TSID, value between 8 and 15, for other data streams;
Bit B4 is used by a non-AP station to differentiate the meaning of bits B8-B15 and is detailed here below;
Bits B5 and B6 define the ACK policy subfield which specifies the acknowledgment policy associated with the data frame. This subfield is used to determine how the data frame has to be acknowledged by the receiving station; normal ACK, no ACK or Block ACK.
Bit B7 is reserved, meaning not used by the current 802.11 standards; and
If bit B4 is set to 1, bits B8-B15 represent the “queue size” subfield 203, to indicate the amount of buffered traffic for a given TID at the non-AP station sending this frame. The queue size value is the total size, rounded up to the nearest multiple of 256 octets and expressed in units of 256 octets, of all packets buffered for the specified TID. The access point may use this information to determine the next TXOP duration it will grant to the station. A queue size of 0 indicates the absence of any buffered traffic for that TID. A queue size of 255 indicates an unspecified or unknown size for that TID 204.
Alternatively to the “queue size” usage, if bit B4 is set to 0, bits B8-B15 represent the “TXOP Duration Requested” subfield. It indicates the duration, in units of 32 μs, that the sending station determines it needs for its next TXOP for the specified TID. Of course, the “TXOP Duration Requested” provides an equivalent request as the “queue size”, as they both consider all packets buffered for the specified TID.

The 802.11e MAC frame format, and more particularly the QoS Control field 200, have been kept for the up and corner standard versions as now described. The following description will be done with “queue size” format for the buffer status reports, as it is the largest usage. The invention remains applicable to the “TXOP Duration Requested” format.

To meet the ever-increasing demand for faster wireless networks to support bandwidth-intensive applications, 802.11ac is targeting larger bandwidth transmission through multi-channel operations. FIG. 3 illustrates 802.11ac channel allocation that supports composite channel bandwidth of 20 MHz, 40 MHz, 80 MHz or 160 MHz.

IEEE 802.11ac introduces support of a restricted number of predefined subsets of 20 MHz channels to form the sole predefined composite channel configurations that are available for reservation by any 802.11ac station on the wireless network to transmit data.

The predefined subsets are shown in FIG. 3 and correspond to 20 MHz, 40 MHz, 80 MHz, and 160 MHz channel bandwidths, compared to only 20 MHz and 40 MHz supported by 802.11n. Indeed, the 20 MHz component channels 300-1 to 300-8 are concatenated to form wider communication composite channels.

In the 802.11ac standard, the channels of each predefined 40 MHz, 80 MHz or 160 MHz subset are contiguous within the operating frequency band, i.e. no hole (missing channel) in the composite channel as ordered in the operating frequency band is allowed. As an exception, the 160 MHz channel bandwidth is composed of two 80 MHz channels that may or may not be frequency contiguous. The 80 MHz and 40 MHz channels are respectively composed of two frequencies adjacent or contiguous 40 MHz and 20 MHz channels, respectively. The present invention may have embodiments with either composition of the channel bandwidth, i.e. including only contiguous channels or formed of non-contiguous channels within the operating band.

A station is granted a TxOP through the enhanced distributed channel access (EDCA) mechanism on the “primary channel” 300-3. Indeed, for each composite channel having a bandwidth, 802.11ac designates one channel as “primary” meaning that it is used for contending for access to the composite channel. The primary 20 MHz channel is common to all stations (STAs) belonging to the same basic set, i.e. managed by or registered to the same local Access Point (AP).

However, to make sure that no other legacy station (i.e. not belonging to the same set) uses the secondary channels, it is provided that the control frames (e.g. RTS frame/CTS frame) reserving the composite channel are duplicated over each 20 MHz channel of such composite channel.

As addressed earlier, the IEEE 802.11ac standard enables up to four, or even eight, 20 MHz channels to be bound. Because of the limited number of channels (19 in the 5 GHz band in Europe), channel saturation becomes problematic. Indeed, in densely populated areas, the 5 GHz band will surely tend to saturate even with a 20 or 40 MHz bandwidth usage per Wireless-LAN cell. Developments in the 802.11ax standard seek to enhance efficiency and usage of the wireless channel for dense environments.

In this perspective, one may consider multi-user (MU) transmission features, allowing multiple simultaneous transmissions to different users in both downlink and uplink directions. In the uplink (UL), multi-user transmissions can be used to mitigate the collision probability by allowing multiple stations to simultaneously transmit.

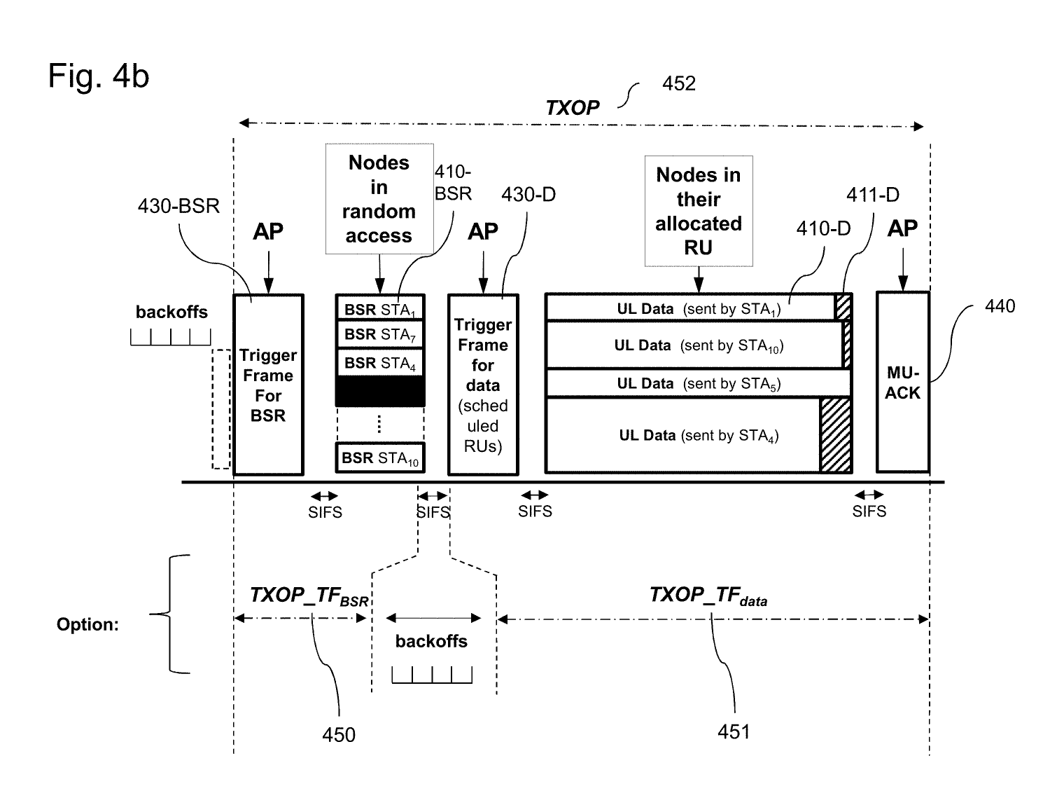

To actually perform such multi-user transmission, it has been proposed to split at least one granted 20 MHz channel 300-1 to 300-4 into elementary sub-channels 410 in FIG. 4a, also referred to as sub-carriers or resource units (RUs), that are shared in the frequency domain by multiple users, based for instance on Orthogonal Frequency Division Multiple Access (OFDMA) technique.

This is illustrated with reference to FIG. 4a which illustrates an example of OFDMA transmission scheme. In this example, each 20 MHz channel 300-1, 300-2, 300-3 or 300-4 is sub-divided in frequency domain into four OFDMA sub-channels or resource units 310 of size 5 MHz. These sub-channels (or resource units or sets of “sub-carriers”) may also be referred to as “traffic channels”.

Of course the number of resource units splitting a 20 MHz channel may be different from four. For instance, between two to nine resource units may be provided thus each having a size between 10 MHz and about 2 MHz. It is also possible to have a resource unit width greater than 20 MHz, when included inside a wider composite channel, for example 80 MHz. Contrary to downlink OFDMA wherein the access point can directly send multiple data to multiple stations, supported by specific indications inside the PLCP header, a trigger mechanism has been adopted for the access point to trigger uplink communications from various stations.

To support an uplink multi-user transmission, during a pre-empted TXOP, the 802.11ax access point has to provide signalling information for both legacy stations, namely non-802.11ax stations, to set their NAV to prevent any transmission during the TXOP, and for 802.11ax stations to determine the Resource Units allocation.

In the following description, the term legacy stations refers to non-802.11ax stations, meaning 802.11 stations of previous technologies that do not support OFDMA communications.

As shown in the example of FIG. 4a, the access point sends a trigger frame (TF) 430 to the targeted 802.11ax stations. The bandwidth or width of the targeted composite channel is signalled in the TF frame, meaning that the 20, 40, 80 or 160 MHz value is added. The TF frame is sent over the primary 20 MHz channel and duplicated, replicated, on each other 20 MHz channels forming the targeted composite channel. Thanks to the duplication of the trigger frame, it is expected that every nearby legacy station receiving the TF on its primary channel, then sets its NAV to the value specified in the TF frame. This prevents these legacy stations from accessing the channels of the targeted composite channel during the TXOP.

Based on an access point's decision, the trigger frame 430 may define a plurality of resource units (RUs) 410. The multi-user feature of OFDMA allows the access point to assign different resource units to different stations in order to increase competition. This may help to reduce contention and collisions inside 802.11 networks.

The trigger frame 430 may designate “Scheduled resource units”, which may be reserved by the access point for certain stations in which case no contention for accessing such resource units is needed for these stations. Such resource units and their corresponding scheduled stations are indicated in the trigger frame. For instance, a station identifier, such as the Association ID (AID) assigned to each station upon registration, is added in association with each Scheduled resource unit in order to explicitly indicate the station that is allowed to use each Scheduled resource unit. Such transmission mode is concurrent to the classical EDCA, and the uplink data to be sent to the access point is picked from the EDCA queues 210.

The trigger frame 430 may also designate “Random resource units”, in addition or in replacement of the “Scheduled resource units”, which can be randomly accessed by the stations of the network. In other words, Random resource units designated or allocated by the access point in the TF may serve as basis for contention between stations willing to access the communication medium for sending data. A collision occurs when two or more stations attempt to transmit at the same time over the same resource unit. An AID equal to 0 may be used to identify random resource units.

A random allocation procedure is under definition by 802.11ax standard, and is based on a new backoff counter (OFDMA backoff, or OBO) inside the 802.11ax non-AP stations for allowing a contention in an resource unit to send data. This OBO backoff, while in concurrence to the EDCA backoff engines 211 for allowing transmission onto the wireless channel, will empty the same EDCA queues 210. The OFDMA random allocation procedure comprises, for a station of a plurality of 802.11ax stations having an positive OBO backoff value, initially drawn inside an OFDMA contention window range, a first step of determining from a received trigger frame the sub-channels or resource units of the communication medium available for contention (the so-called “random resource units”), a second step of verifying if the value of the OBO backoff value local to the considered station is not greater than the number of detected-as-available random resource units, and then, in case of successful verification, a third step of randomly selecting a resource unit among the detected-as-available resource units for sending data. In case of second step is not verified, a fourth step (instead of the third) is performed in order to decrement the OBO backoff value by the number of detected-as-available random resource units.

As one can note, an OFDMA transmission according random procedure is not ensured for each trigger frame reception: at least the OBO is decremented upon each reception of a trigger frame with “random resource units”, which differs transmission to any one of subsequent trigger frames depending of OBO value and number of random resource units offered by those further received TFs.

In the example of FIG. 4a, each 20 MHz channel 400-1, 400-2, 400-3 or 400-4 is sub-divided in frequency domain into four sub-channels or resource units 410, typically of size 5 MHz. Of course the number of resource units splitting a 20 MHz channel may be different from four. For instance, between two to nine resource units may be provided, thus each having a size between 10 MHz and about 2 MHz.

As shown in FIG. 4a, some Resource Units 410u may not be used because no station with an OBO backoff value less than the number of available random resource units has randomly selected one of these resource units, whereas some other 410c are collided, the black ones on FIG. 4a, because at least two of these stations have randomly selected the same random resource unit. This shows that due to the random determination of random resource units to access, collision may occur over some resource units, while other resource units may remain free. The used resource units 410 may be fit by stations following the allocation scheme information, namely the value AID, provided inside the trigger frame, scheduled to a given AID non-zero value, or random when AID equals zero. Once the stations have used the resource units to transmit data to the access point, the access point responds with a Multi-User acknowledgment, not show in FIG. 4a, to acknowledge the data on each resource unit.

The FIG. 4b provides an exemplary scenario of 802.11ax, wherein successive trigger frames, first fully random-type then second fully scheduled-type, are used in order that an access point polls stations having uplink data.

Since the receiver, the access point, performs contention on behalf of the non-AP stations in the uplink OFDMA, the access point should be aware of both which non-AP stations have uplink packets and what their buffer 210 sizes are. If non-AP stations without uplink packets are polled for uplink OFDMA transmission, then allocated uplink resources are wasted thus leading to wireless medium usage degradation.

The standard proposes that buffer status report from 802.11ax stations may be utilized to support the efficient uplink MU operation by the access point. Upon reception of a trigger frame 430-BSR containing a request indication of buffer status report, a 802.11ax station responds with a frame including the Queue Size subfield 203 in its QoS Control field 200. The indication of buffer status report may be, for example, a “Trigger Type” provided inside the Trigger Frame, and a specific value indicates such buffer status request. The trigger frame 430-BSR is seen as a trigger frame for Buffer Status Report (BSR) by the station.

Preferably, the trigger frame 430-BSR is emitted in broadcast in order to reach all stations of the BSS, and the, most even all, resource units are of random-type to allow any station a random opportunity to provide a queue size report. In addition, it is preferable to try to reach a maximum of stations, then the maximum number of resource units should be provided, that is to say among the widest channel band and with the narrowest resource unit sizes.

In order to minimize the duration of the buffer state report, the frames sent inside resource units 410-BSR should be limited and of same size to avoiding inefficient padding. For example, a QoS_Null frame seems better appropriated. This specific QoS Data frame contains the QoS Control field with queue size information, but no data payload.

A current version of IEEE 802.11ax extends the usage of Queue size information 203 in a new QoS Control field, namely HE Control, and possibly in replacement of QoS Control field for 802.11ax frames, in order to inform about the several queues 210, instead on only one, according to 802.11e.

Once the access point has obtained buffer reports for a set of stations of its BSS, it can specifically poll them through scheduled resource unit allocation. This allocation is transmitted using a trigger frame 430-D for data transmission. Then, the stations with allocated resource units emits their buffered data during a longer TXOP_TF_{data} 451 and inside their allocated resource unit 410-D. As the MU UL/DL OFDMA transmissions on all the resource units of the composite channel should be aligned in time, the station may provide padding payload 411-D in case of no more data can be sent inside the assigned resource unit. This may happen, for example, if no more data is buffered for transmission, or if the emitting station doesn't want to fragment any remaining data frame.

The access point is able to manage the resource unit size according to the reported needs. The access point may schedule the uplink resource unit(s) during the TXOP period to any of the stations having sent a report.

Once the stations have used the resource units 410-D to transmit data to the access point, the access point responds with a Multi-User acknowledgment 440 to acknowledge the data on each resource unit. This ACK ends the granted TXOP period.

Regarding the organization of TXOP, two embodiments may be contemplated. In a first embodiment, the whole transmission, namely the trigger frame for BSR 430-BSR, the BSR response 410-BSR from the stations, the trigger frame for data 430-D, the data transmission 410-D, 411-D and acknowledgement 440 are grouped into an unique TXOP 452. In a second embodiment, a first TXOP, TXOP_TF_{BSR}, is provided for the trigger frame for BSR 430-BSR and the BSR response 410-BSR from the stations. Next, the channel is released. A second TXOP, TXOP_TF_{data}, is provided for the trigger frame for data 430-D, the data transmission 410-D, 411-D and acknowledgement 440.

It is up to the access point to decide if first and second TXOPs are separated or pertaining to a unique TXOP, in which case only a SIFS delay is mandatory before emitting the trigger frame 430-D.

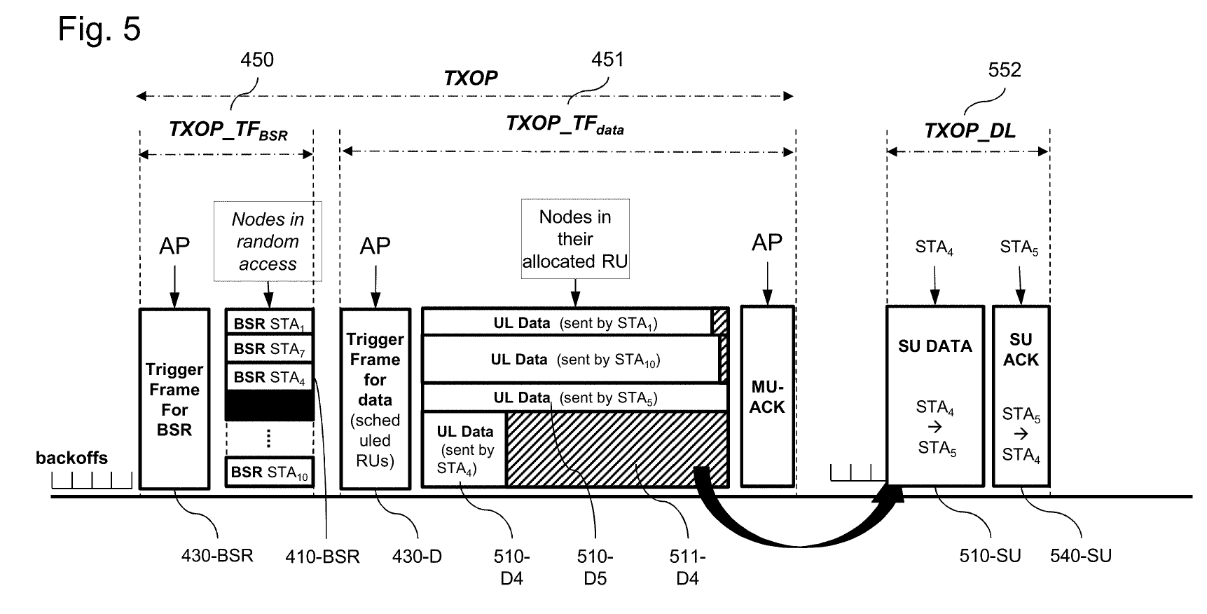

FIG. 5 provides a demonstrative scenario, wherein the theoretical scenario of FIG. 4a envisaged by the 802.11ax standard suffers from inefficiencies.

As recalled, communications inside a P2P group are concurrent to communications of the infrastructure network, including the access point 110. That is, the stations involved at the same time in the P2P communications and BSS network have their transmission queue(s) served with data from both traffic modes.

The 802.11 classical usage for constructing/using such buffer status reports is no longer adapted to this transmission concurrency, as the overall buffer status is reported inside the queue size information of their buffer reports. To report the buffer status for a given TID, a 802.11 station shall set the Queue Size subfield in a QoS Data or a QoS Null frame to the amount of queued traffic present in the output queue belonging to the specified TID. The 802.11ax may extend the single-TID report of 802.11e to offer a multiple-TID report version, but the determination baseline is still the same, the queue size.

This conducts to a misinformation received by the access point, which then is misled for allocation resource units to 802.11ax stations. This situation has not been addressed by the 802.11ax standardization group, because it concentrates its activities around the access point traffic. The P2P traffics is considered as “background” communications of less importance.

Back to FIG. 5, due to a concurrent P2P communication, the station 4 has reported 410-BSR an important buffer occupation to the access point, which conducts to obtain a large resource unit for uplink data: as a consequence, the allocated resource unit is composed of a data portion 510-D4 followed by an important padding 511-D4, because the access point grants uplink resources to a station based on the buffer status report. The fact that the buffer status report takes into account both the traffic destined to the access point and the traffic destined to another non-AP station using a P2P protocol, leads the access point to allocate too many resources to the station. The padding 511-D4 is pure lost, and may represent the quasi totality of the resource units allocated to the station 4. In all cases, the station 4 will still have to contention through EDCA to transmit its P2P data 120 in the Single User frame 510-SU during the TXOP_DL 552.

This issue is really detrimental for dense scenarios addressed by 802.11ax, for at least the following 3 reasons:

Important resource unit allocation may not be used. In addition to a worse efficiency of the global system, energy for transmitting padding is consumed by the 802.11ax station.

Some 802.11ax stations with pending uplink traffic may have no allocation. For example, the case of station STA 7 which has sent a buffer report, but has not obtained any allocated resource unit, and their buffers are crowding. As a result, such stations will try emptying their transmission buffers through EDCA medium accesses, which increases collision probability.

The 802.11ax with P2P communications will still require an EDCA access for emitting its pending traffic.

The present invention seeks to improve the reservation of the resource units (RUs) for multi-user transmission. To do so, an aim of this invention is to provide more reliable buffer status reports from an 802.11ax station to the 802.11ax access point, as a countermeasure to the raised issues.

An exemplary wireless network for the implementation of embodiments of the invention is an IEEE 802.11ax network or one of its future versions. However, the invention applies to any wireless network comprising stations, for instance an access point 110 and a plurality of stations 101-107 exchanging data through a single-user, for example P2P communication between stations, and multi-user transmissions from non-AP stations to the access point. The invention is especially suitable for data transmission in resource units of an IEEE 802.11ax network and its future versions.

An exemplary management of single-user and multi-user transmissions in such a network has been described above with reference to FIGS. 1 to 5.

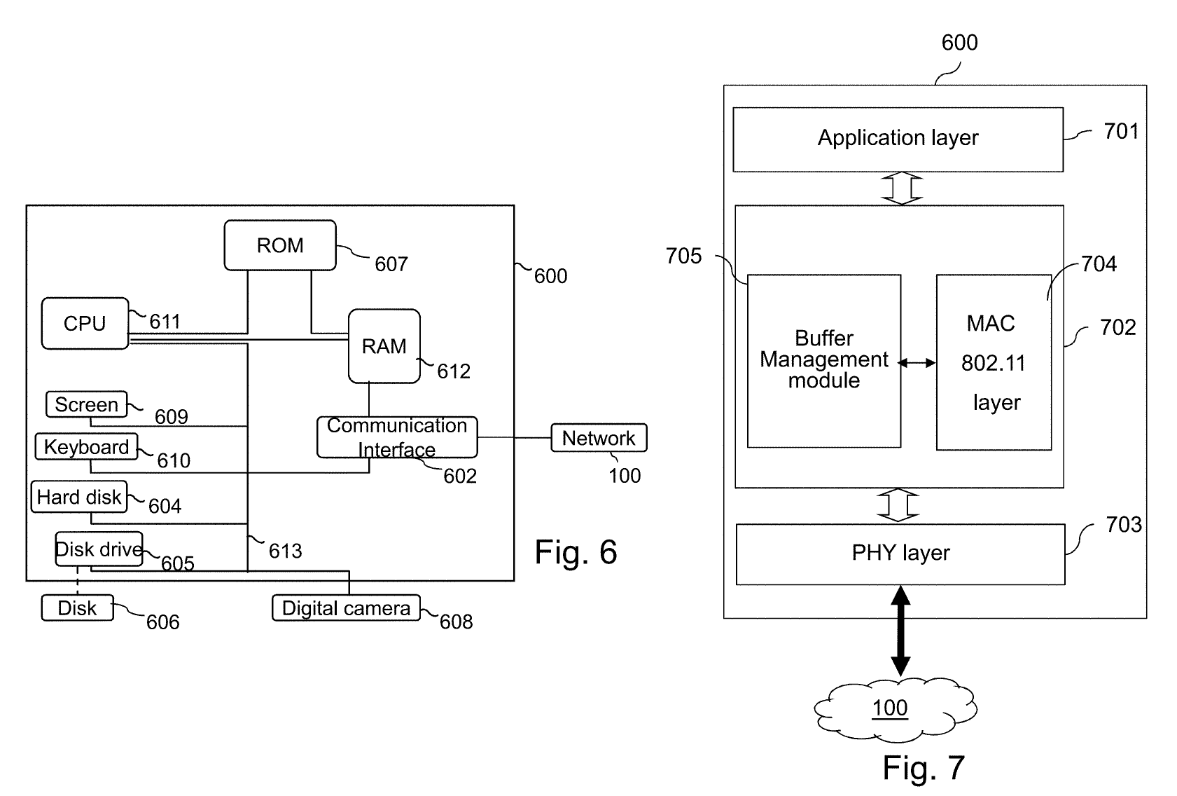

FIG. 6 schematically illustrates a communication device 600 of the radio network 100, configured to implement at least one embodiment of the present invention. The communication device 600 may preferably be a device such as a micro-computer, a workstation or a light portable device. The communication device 600 comprises a communication bus 613 to which there are preferably connected:
a central processing unit 611, such as a microprocessor, denoted CPU;
a read only memory 607, denoted ROM, for storing computer programs for implementing the invention;
a random access memory 612, denoted RAM, for storing the executable code of methods according to embodiments of the invention as well as the registers adapted to record variables and parameters necessary for implementing methods according to embodiments of the invention; and
at least one communication interface 602 connected to the radio communication network 100 over which digital data packets or frames or control frames are transmitted, for example a wireless communication network according to the 802.11ax protocol. The frames are written from a FIFO sending memory in RAM 612 to the network interface for transmission or are read from the network interface for reception and writing into a FIFO receiving memory in RAM 612 under the control of a software application running in the CPU 611.

Optionally, the communication device 600 may also include the following components:
a data storage means 604 such as a hard disk, for storing computer programs for implementing methods according to one or more embodiments of the invention;
a disk drive 605 for a disk 606, the disk drive being adapted to read data from the disk 606 or to write data onto said disk;
a screen 609 for displaying decoded data and/or serving as a graphical interface with the user, by means of a keyboard 610 or any other pointing means.

The communication device 600 may be optionally connected to various peripherals, such as for example a digital camera 608, each being connected to an input/output card (not shown) so as to supply data to the communication device 600.

Preferably the communication bus provides communication and interoperability between the various elements included in the communication device 600 or connected to it. The representation of the bus is not limiting and in particular the central processing unit is operable to communicate instructions to any element of the communication device 600 directly or by means of another element of the communication device 600.

The disk 606 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to the invention to be implemented.

The executable code may optionally be stored either in read only memory 607, on the hard disk 604 or on a removable digital medium such as for example a disk 606 as described previously. According to an optional variant, the executable code of the programs can be received by means of the communication network 603, via the interface 602, in order to be stored in one of the storage means of the communication device 600, such as the hard disk 604, before being executed.

The central processing unit 611 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 604 or in the read only memory 607, are transferred into the random access memory 612, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

FIG. 7 is a block diagram schematically illustrating the logical architecture of the communication device or station 600, either one of the stations 101-107 adapted to carry out, at least partially, the invention. As illustrated, station 600 comprises a physical (PHY) layer block 703, a MAC layer block 702, and an application layer block 701.

The PHY layer block 703 (e.g. a 802.11 standardized PHY layer) has the task of formatting, modulating on or demodulating from any 20 MHz channel or the composite channel, and thus sending or receiving frames over the radio medium used 100, such as 802.11 frames, for instance single-user frames, such as control frames (RTS/CTS/ACK/Trigger Frame), MAC data and management frames, based on a 20 MHz width to interact with legacy 802.11 stations, as well as MAC data frames of OFDMA type having smaller width than 20 MHz legacy (typically 2 or 5 MHz) to/from that radio medium.

The MAC layer block or controller 702 preferably comprises a MAC 802.11 layer 704 implementing conventional 802.11ax MAC operations, and one additional block 705 for carrying out, at least partially, embodiments of the invention. The MAC layer block 702 may optionally be implemented in software, which software is loaded into RAM 612 and executed by CPU 611.

Preferably, the additional block 705 is a buffer management module which drives the station in computing buffer size information to be provided for a requesting station, in particularly wherein the requesting station is the access point station that will use this reported information for allocating uplink OFDMA resources to the station 600.

For instance and not exhaustively, the operations at the station may include, by module 705, generating and updating stored data information per given destination device, and may include building a buffer status information in regards to the device reclaiming this report.

On top of the Figure, application layer block 701 runs an application that generates and receives data packets, for example data packets of a video stream. Application layer block 701 represents all the stack layers above MAC layer according to ISO standardization.

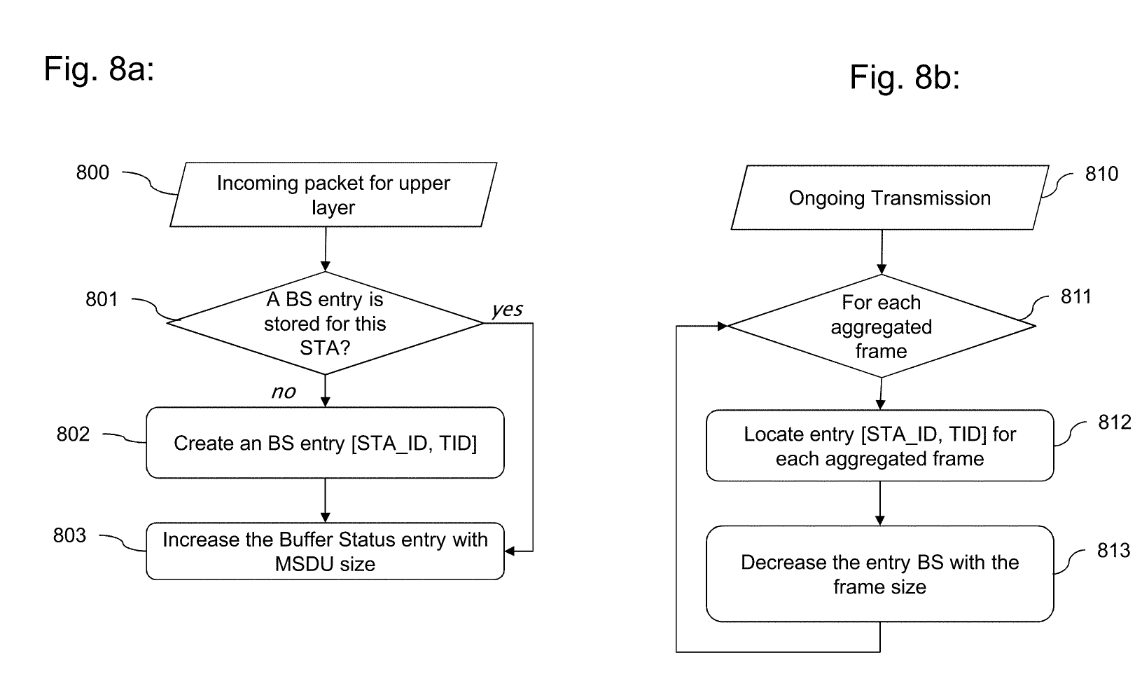

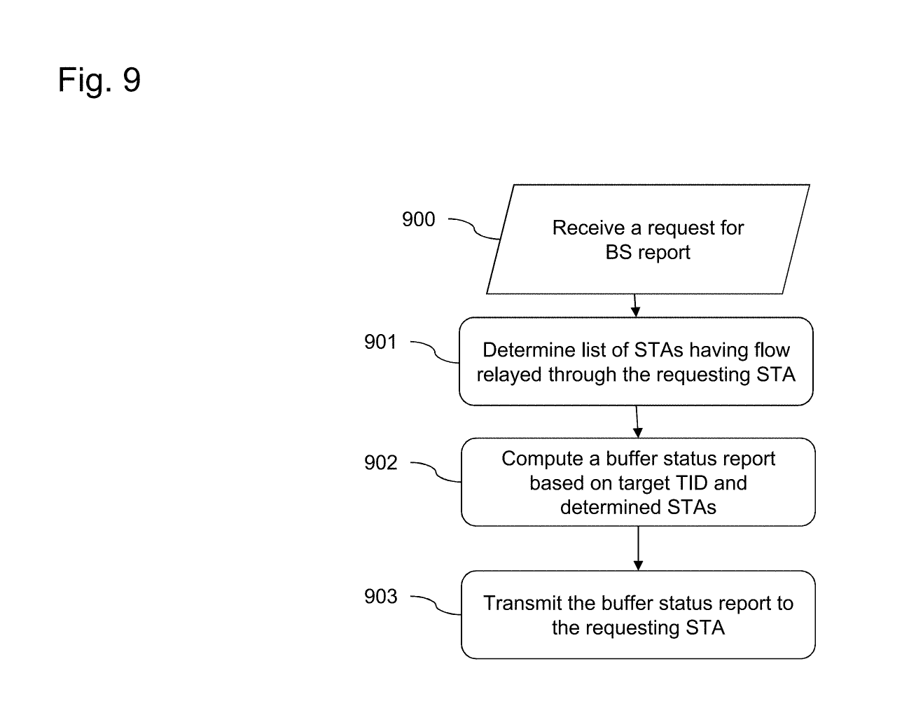

Embodiments of the present invention are now illustrated through different flowcharts describing the behaviour at the stations' side (FIGS. 8 and 9). They are described in the context of IEEE 802.11ax by considering OFDMA sub-channels. These embodiments supplement the 802.11ax by specifying how the stations can report their buffer status to the access point, either in the existing 802.11e frames or in newly 802.11ax multi-user QoS Data/Null frames; and how the stations updates their buffer information upon incoming traffic from upper layers 701.

More specifically, to report the buffer status to the access point, an 802.11ax station should only consider the amount of data queued in direction to the access point (i.e. for uplink transmission); or in other words, should build buffer status report only with regards to uplink transmissions, namely directed towards or relayed by the access point. For example, this report does not include transmissions from 802.11ax stations to a peer non-AP 802.11ax station once a direct link transmission is established in between these at least two stations.

In regards to the Queue Size 203, the Queue Size subfield would now be an 8-bit field that indicates the amount of buffered traffic, to be sent to the station receiving this frame, for a given traffic class (TC) or traffic stream (TS) at the station sending this frame. The queue size value is the total size of all MSDUs and A-MSDUs buffered at the station, excluding the MSDU or A-MSDU of the present QoS Data frame, and excluding MSDU or A-MSDU not intended to be delivered to the receiving station (STA), in the delivery queue used for MSDUs and A-MSDUs with TID values equal to the value in the TID subfield of this QoS Control field.

As an alternative embodiment, the “TXOP Duration Requested” format may be used to indicate the duration that the sending station determines it needs for its next 20 MHz-normalized TXOP to the requesting station and for the specified TID. This duration is normalized over a 20 MHz band, in order to be scaled by the access point according resource unit width. This is a means to determine the adjusted duration according the downscaled bandwidth ratio from 20 MHz to the resource unit width.

As an alternative embodiment, the “TXOP Duration Requested” subfield format is forbidden or not used for 802.11ax stations, in favor of the “queue size” format: an 802.11ax station shall only use the “queue size” format in QoS Data frames for buffer status feedback operation for uplink MU.

Embodiments of the present invention are now illustrated through a flowchart illustrating main steps of the process at station 600 when receiving a MSDU packet from upper layer 701 (FIG. 8a), and when transmitting the stored MSDU packet to wireless interface 703 (FIG. 8b).

These algorithms present improvement of the process of buffer status reports, since a more classical, but less efficient in term of delay, would be to store as usual the data in buffers 210, and only build the report upon request. This basic solution is less and less feasible with regards to 802.11ax very high throughput and large amount of buffered data, as the same SIFS delay is kept among various 802.11 protocol versions for building a response. This means that a station 600, with regards to FIG. 9, has to provide a dedicated buffer report according to the requester station, and would need to parse all the buffered frames, maybe in up to the 4 buffers 210, for building the report.

It is thus envisaged to keep in memory 612 an up-to-date data structure of buffered data. Typically, it can take of a lightweight database, where the key entry is the MAC address of destination station. Buffer information per Traffic Identifier, TID 204, are linked to this entry. For the following, the term “BS_Table” represents the structure in memory which associates a buffer information per TID for a given final destination station. An entry of this table may be accessed, for example from an association [STA_ID, TID], wherein STA_ID is an address identifier of a destination station, typically its MAC address. Typically, the buffer information includes at least a buffer size information representative of an amount of data buffered per TID for a given final destination station.

The final destination station identification helps in supporting the invention, because the classical consideration of “next hop station” is not stable along the lifetime of a buffered packet: if a direct link is established between two non-AP stations, then the “next hop station” is no longer the relying access point but the final destination while final destination station is always the same during the lifetime of a MSDU.

As an advantage, the information of buffered data can be obtained quickly, and the granularity of the report is tunable either per TID, or per Access Category, or for the overall 4 buffers. Advantageously, the trigger frame for buffer status report comprises an information related to whether the buffer status report should be established for a given traffic identifier, a given access category or the whole traffic. Further advantages will become apparent in regards to FIG. 9 description.

Back to FIG. 8a, at step 800, a new MSDU packet is received from upper layer 701. This packet will be analysed to determine the address of the recipient, namely the final destination address of the frame.

Based on this MAC address, test 801 consists in verifying if buffer report information is already prepared for this destination station, that is to say a BS entry is present in the BS_Table in the particular embodiment. If no entry is found, it is created in step 802, from the MAC address of the destination station (STA_ID) and the TID provided inside the MSDU packet.

Next, step 803 conducts to update the BS entry for the given station: the buffer size information of BS entry is increased by the MSDU size. The MSDU packet is then inserted in the AC queue 210 corresponding to the TID of MSDU packet.

FIG. 8b is the reverse procedure of FIG. 8a, wherein the amount of buffered data that has been transmitted should be removed from at least one corresponding BS entry. As there is potentially an aggregation of 802.11 frames, the step 811 conducts to an execution loop of steps 812/813.

For 802.11ax EDCA transmissions of single-user type and not destined to the access point, typically the P2P traffic, the AMPDU aggregation envisages aggregating several frames for a same destination: as a consequence, several TIDs may be concerned for a same station.

For 802.11ax EDCA transmissions of single-user type and dedicated to the access point, and for 802.11ax EDCA transmissions of multi-user type, the AMPDU aggregation envisages aggregating several frames for maybe several destination stations: As the access point acts as a central relay for traffic other than P2P traffic, several final destination stations and several TIDs may be addressed in the on-going transmission.

Preferably, the algorithm step 810 is raised for successful transmissions, namely when a positive acknowledgment is received. For each aggregated 802.11 MPDU frame, that is to say either a MPDU being a MSDU, or a MPDU being a A-MSDU, knowing that in A-MSDU all MSDU are of same TID, a BS entry is searched from the final destination ID, typically the MAC address, and the TID of the MPDU.

In step 813, the buffer size information of the found BS entry is reduced from the transmitted MPDU payload size.

FIG. 9 illustrates the creation of a Buffer Status Report when it is requested to a 802.11ax station.

At step 900, a BSR request is received by the non-AP station 600.

Note that this request may be internal to the station, in case of aiming at providing a queue size 203 of a 802.11 frame under transmission. We talk of an internal request when the buffer status report is not built in response to an external request, for example by a trigger frame for status report. It is built in the regular process of building the frame to be able to fill the queue size field 203. It is considered that the request comes from the control, typically the MAC layer entity 704. In that case, the indicated queue size is the remaining size in the queue 210 without considering the current packet. The requesting station is considered to be the destination MAC address of the current 802.11 frame for which the report is internally requested.

This request may also be external to the station. Typically this is performed through a trigger frame of type BSR (430-BSR) emitted by the access point. In that case, the requesting station is considered to be the access point. Even if the description is provided through 802.11ax embodiment, the invention does not limit itself to this sole scenario, but is also applicable to a mesh scenario wherein traffic is relayed by several chained stations.

The step 901 intends to obtain a list of station linked to the requesting station. Typically, this is for the case where several data traffics pass through the requesting station. In practice, this step concerns only the case where the requesting station is the access point. It is worth noting that direct link traffic is established between the emitter and the destination with no relay by another station. In case of direct link traffic, the requesting station is always the same as the final destination traffic. On the contrary, regular station to station traffic is relayed by the access point. This traffic has a requesting station that is the access point while the destination station may be any station in the BSS. As the BS_Table is organized by destination station, when the requesting station is the access point, it is needed to aggregate all traffic running through the access point to destination stations.

Step 901 determines the list of stations by including all final destination stations of the BSS, namely for which station 600 has pending data, excepting the stations having a direct link established with station 600. This advantageously ensures avoiding reporting active direct link traffics.

Then, step 902 performs an extraction of the buffer information from BS_Table for each determined station as issued from step 901.

Even if the granularity of buffer information is stored at TID level in the BS_Table, the report may be easily provided at any larger grain: several Traffic Identifiers (TID) requested, at Access Category (AC) level, we recall that in 802.11 systems, there are two TIDs per Access-Category (AC) queue 210, with a maximum of 4 queues, or at station comprising the traffic of all queues. This would advantageously support any evolution of 802.11 standards.

That is, if a given TID is requested, as in the case of queue size 203 of existing 802.11e QoS Control field, then each entry [STA_ID, TID] is summed according the list of determined stations. If several TIDs are requested, for example 2 by AC or 8 per station, the previous lookup is enlarged to each entry [STA_ID, TID], where TID values match the request. The buffer report content consists in the sum of buffered information stored by each entry.

Finally, the buffer report is provided to the requester inserted in QoS Control field of a pending data frame or provided inside a new QoS Data/Null frame for BSR report.

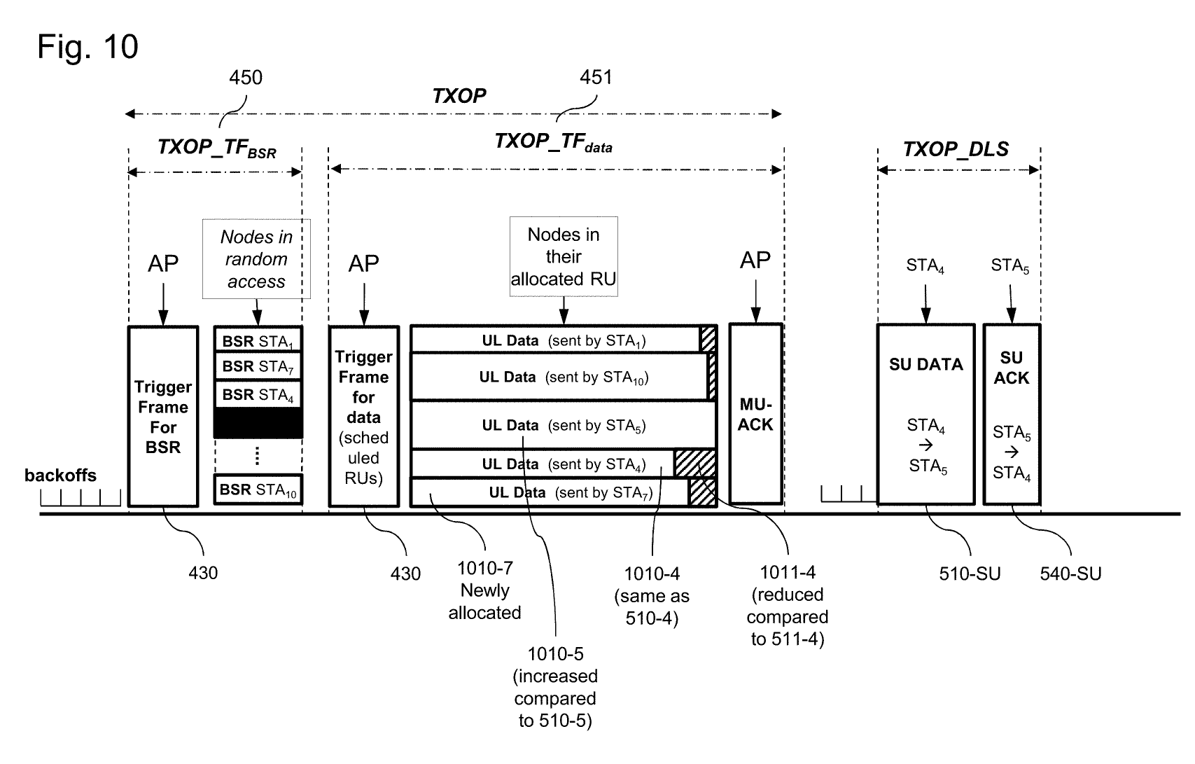

FIG. 10 illustrates, using a timeline, a scenario of reserving resource unit channels according to embodiments of the invention. This timeline describes the effect of invention in regards to the issues raised by FIG. 5 in the context of 802.11ax.

Upon being requested a Buffer Status Report through TF 430-BSR emitted by the access point, the station 4 which is a station 600 embedding the invention will report an adequate buffer status, that is to say corresponding to the queued data frames that are not directed to peer non-AP stations having an established direct link with the requested station 600.

Thus, the access point is informed about a limited need, greatly reduced compared to the situation of FIG. 5. As a result, the allocated resource unit for station 4 is reduced: the amount of emitted data 1010-4 is comparable to 510-4, even if the distribution is different as the resource unit is finer. More important, the padding 1011-4 has mostly disappeared compared to the 511-4.

This leaves room for the access point to allocate resource units to other stations, such as station 7, see the QoS Data 1010-7, which now has opportunity to transmit, and such as for example station 5 which is offered a larger resource unit.

One can note the single-user communication 510-SU is not modified.

However, in other embodiments, the access point may decide to forward the station 4 uplink communication to a later TXOP, thus liberating more wireless resources for other stations of the BSS.

By adopting a correct reporting by stations 600 according to the invention, the resource unit allocation is more efficient in dense scenarios like envisaged in 802.11ax. The allocation of uplink resources by the access point is performed in regards to the real needs of non-AP stations.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of communication in a wireless network comprising a plurality of wirelessly communicating stations, the method comprising by at least one emitting station having data to be directly transmitted to at least two different destination stations:
generating a buffer status report to be transmitted to one of the destination stations, the buffer status report indicating an amount of data stored in at least an emission buffer of the emitting station, the emission buffers comprising all data to be transmitted to all the destination stations;
transmitting the buffer status report to the destination station; wherein
the amount of data is limited to the amount of data stored in at least an emission buffer of the emitting station to be transmitted to the destination station that will receive the buffer status report.

2. The method of claim 1, one station playing the role of access point, the other stations being connected to the access point station, wherein the destination station that will receive the buffer status report is the access point station.

3. The method of claim 1, wherein data to be transmitted to a non access point station are to be emitted according to an established direct link.

4. The method of claim 3, wherein the established direct link is of single-user type.

5. The method of claim 1, further comprising:
maintaining by the emitting station a value representative of an amount of data stored in the emission buffers per final destination station of the stored data.

6. The method of claim 5, wherein data being transmitted according to a plurality of traffic identifiers, the maintained value representative of an amount of data is maintained per final destination and per traffic identifier.

7. The method of claim 6, further comprising for generating the buffer status report the steps of:
determining the list of all final destination stations which traffic is to be transmitted through the destination station that will receive the buffer status report for at least one given traffic identifier;
adding the maintained values representative of an amount of data relating to the determined list of final destination stations for at least one given traffic identifier.

8. The method of claim 1, wherein the method further comprises:
receiving a trigger frame for buffer status report; and wherein
generating a buffer status report is done in response to the reception of the trigger frame for buffer status reports.

9. The method of claim 8, wherein the trigger frame for buffer status report comprises an information related to whether the buffer status report should be established for a given traffic identifier, a given access category or a plurality of access categories.

10. The method of claim 1, wherein generating a buffer status report is done for an introduction within a data frame to be transmitted.

11. The method of claim 1, wherein the buffer status report comprises duration information corresponding to the amount of data to be transmitted on a single 20 MHz channel.

12. The method of claim 1, wherein use of duration information in a buffer status report is forbidden.

13. A computer-readable storage medium storing instructions of a computer program for implementing a method according to claim 1.
